(19) United States
(12) Patent Application Publication
(10) Pub. No.: US 2025/0342098 A1
(43) Pub. Date: Nov. 6, 2025

(54) DEVICE DISPOSITION MANAGEMENT

(71) Applicant: Dell Products L.P., Round Rock, TX (US)

(72) Inventors: Lakshmi Saroja Nalam, Bangalore (IN); Parminder Singh Sethi, Ludhiana (IN); Vasanth Sathyanarayanan, Bangalore (IN)

(21) Appl. No.: 18/653,283

(22) Filed: May 2, 2024

(51) Int. Cl. G06F 11/34; G06Q 10/30

(52) U.S. Cl. CPC G06F 11/3409; G06Q 10/30

(57) ABSTRACT

A method comprises collecting operational data from a plurality of devices, predicting one or more details corresponding to disposition of respective ones of the plurality of devices based at least in part on the operational data, and generating and causing transmission of one or more alerts to at least one user device based at least in part on the one or more details corresponding to the disposition of the respective ones of the plurality of devices.

### FIELD

The field relates generally to information processing systems, and more particularly to device disposition management in such information processing systems.

### BACKGROUND

After using devices for certain durations, users may approach an enterprise to resell or recycle the devices. With current approaches, users typically wait until devices stop working and/or stop working as expected, often resulting in the devices deteriorating beyond the point where they can be refabricated and/or resold. The conventional approaches decrease device sustainability, cause excessive power consumption by devices in disrepair and, overall, result in an increased carbon footprint. Additionally, current approaches are reactive to device failures, and are not capable of identifying when devices may fail, thereby limiting an enterprise's ability to prevent and/or minimize adverse effects of such failures.

### SUMMARY

Embodiments provide a device disposition management platform in an information processing system.

For example, in one embodiment, a method comprises collecting operational data from a plurality of devices, predicting one or more details corresponding to disposition of respective ones of the plurality of devices based at least in part on the operational data, and generating and causing transmission of one or more alerts to at least one user device based at least in part on the one or more details corresponding to the disposition of the respective ones of the plurality of devices.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a device disposition management platform for predicting and controlling disposition of devices in an illustrative embodiment.

FIG. 2 depicts an operational flow for device disposition in an illustrative embodiment.

FIG. 3 depicts a graph of factors for determining device resale value in an illustrative embodiment.

FIG. 4 depicts a graph of factors for determining when to recycle a device instead of reselling the device and for determining device recycle value in an illustrative embodiment.

FIG. 5 depicts a screenshot of a user interface illustrating resale devices and corresponding resale values in an illustrative embodiment.

FIG. 6 depicts a screenshot of a user interface illustrating recycle devices and corresponding recycle values in an illustrative embodiment.

FIG. 7 is a flow diagram of an exemplary process for predicting and controlling disposition of devices in an illustrative embodiment.

FIGS. 8 and 9 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous, and a user device receives messages without any significant time delay. Of course, it should be understood that depending on the particular temporal nature of the system in which an embodiment is implemented, other appropriate timescales that provide at least contemporaneous performance and output can be achieved.

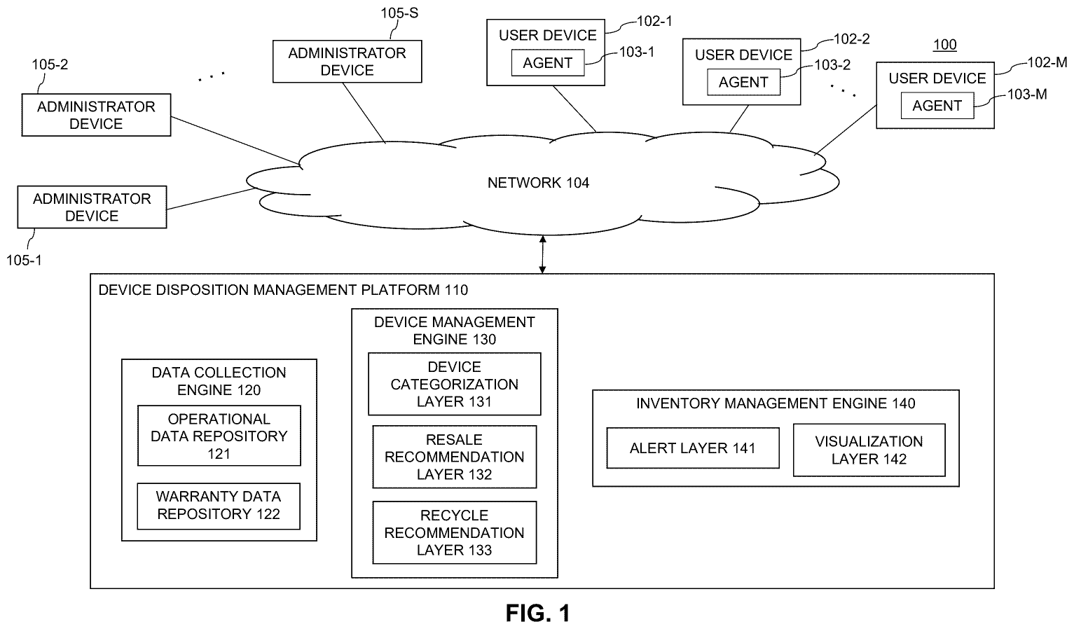

FIG. 1 shows an information processing system 100 configured in accordance with an illustrative embodiment. The information processing system 100 comprises user devices 102-1, 102-2, . . . 102-M (collectively “user devices 102”) and administrator devices 105-1, 105-2, . . . 105-S (collectively “administrator devices 105”). As explained in more detail herein, the user devices 102 comprise respective agents 103-1, 103-2, . . . 103-M (collectively “agents 103”). The agents 103 comprise software agents and one or more APIs that are deployed on the user devices 102 to, for example, monitor the operation of the user devices 102 and to collect data corresponding to the operation of the user devices 102.

The user devices 102 and administrator devices 105 communicate over a network 104 with a device disposition management platform 110. The variable M and other similar index variables herein such as K, L and S are assumed to be arbitrary positive integers greater than or equal to one. The user devices 102 and administrator devices 105 comprise, for example, desktop, laptop or tablet computers, servers, host devices, storage devices, mobile telephones, Internet of Things (IoT) devices or other types of processing devices capable of communicating with the device disposition management platform 110 over the network 104. Such devices are examples of what are more generally referred to herein as “processing devices.” Some of these processing devices are also generally referred to herein as “computers.” The user devices 102 and administrator devices 105 may also or alternately comprise virtualized computing resources, such as virtual machines (VMs), containers, etc. The user devices 102 and administrator devices 105 in some embodiments comprise respective computers associated with a particular company, organization or other enterprise.

The terms “user,” “customer,” “client,” “personnel” or “administrator” herein are intended to be broadly construed so as to encompass numerous arrangements of human, hardware, software or firmware entities, as well as combinations of such entities. Device disposition services may be provided for users utilizing one or more machine learning models, although it is to be appreciated that other types of infrastructure arrangements could be used. At least a portion of the available services and functionalities provided by the device disposition management platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the device disposition management platform 110, as well as to support communication between the device disposition management platform 110 and connected devices (e.g., user devices 102 and administrator devices 105) and/or other related systems and devices not explicitly shown.

In some embodiments, the user devices 102 and administrator devices 105 are assumed to be associated with repair and/or support technicians, system administrators, information technology (IT) managers, software developers, release management personnel or other authorized personnel configured to access and utilize the device disposition management platform 110.

The device disposition management platform 110 in the present embodiment is assumed to be accessible to the user devices 102 and administrator devices 105 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the device disposition management platform 110 includes a data collection engine 120, a device management engine 130 and an inventory management engine 140. The data collection engine 120 includes an operational data repository 121 and a warranty data repository 122. The device management engine 130 comprises a device categorization layer 131, a resale recommendation layer 132 and a recycle recommendation layer 133. The inventory management engine 140 comprises an alert layer 141 and a visualization layer 142.

The data collection engine 120 collects data from one or more agents 103 and from one or more administrator devices 105. In a non-limiting illustrative embodiment, the administrator devices may be tied to one or more data sources comprising, for example, one or more of a technical support system, a sales system, an order fulfillment system (e.g., supply chain), a customer relationship management (CRM) system and exchange team data. In illustrative embodiments, the data collection engine 120 performs data engineering and data pre-processing to identify the features and the corresponding data elements that will be influencing the predictions made by the device management engine 130. In illustrative embodiments, the data engineering and data pre-processing includes generating multivariate plots and correlation heatmaps to identify the significance of each feature in the collected data, and filter less important data elements. The data engineering and data pre-processing reduces the dimensions and complexity of the machine learning algorithms, hence improving the accuracy and performance of the algorithms. In some embodiments, the data engineering and data pre-processing includes cleaning any unwanted characters and stop words from the data, performing stemming and lemmatization, as well as changing text to lower case, removing punctuation, and removing incorrect or unnecessary characters. In some embodiments, textual values are changed to numerical values (e.g., vectors) for appropriate processing by the machine learning algorithms.

The data may be collected from the agents 103 and administrator devices 105 and/or from applications used for monitoring, mining and/or pulling data from the agents 103 and administrator devices 105. The data comprises, for example, operational data of the user devices 102 including, for example, data corresponding to connection status, power consumption, workloads, crashes, processing failures, data transmission failures, throughput, latency, central processing unit (CPU) utilization and memory utilization of respective ones of the user devices 102. The data further includes, for example, data corresponding to age, warranty status, warranty type and model of the respective ones of the user devices 102. The data also includes, for example, data corresponding to a status of one or more parts, a health of one or more parts, an age of one or more parts, a model of one or more parts and a type of one or more parts of the respective ones of the user devices 102.

In illustrative embodiments, the agents 103 continuously monitor the user devices for changes in operational data and the data collection engine 120 continuously retrieves data from the agents 103 to dynamically capture real-time changes in the operational status of the user devices 102. The data collected by the data collection engine 120 further comprises historical data regarding the disposition of the user devices 102. As explained in more detail herein, historical data regarding the disposition of the user devices 102 includes, for example, whether respective ones of the user devices 102 were resold, whether respective ones of the user devices 102 were recycled, when the respective ones of the user devices 102 were resold, when the respective ones of the plurality of devices were recycled, a resale value of the respective ones of the user devices 102 and a recycle value of the respective ones of the user devices 102. The historical data regarding the disposition of the user devices 102 further includes, for example, operational and warranty data corresponding to situations when respective ones of the user devices 102 were resold, when respective ones of the user devices 102 were recycled, resale values of the respective ones of the user devices 102 and recycle values of the respective ones of the user devices 102. Machine learning algorithms used to predict details corresponding to the disposition of respective ones of the user devices 102 are trained with the historical disposition data. Additionally, the machine learning algorithms are continuously trained and re-trained (e.g., in multiple iterations) with new data comprising new device dispositions and feedback (e.g., user feedback and/or computed accuracy of the machine learning algorithms) regarding the new device dispositions to improve the accuracy of the machine learning algorithms over time.

The operational data collected by the data collection engine 120 may be stored in the operational data repository 121 and the data corresponding to age, warranty status, warranty type and model of the respective ones of the user devices 102 and/or parts can be stored in the warranty data repository 122.

The collected data may include operational data trends captured by, for example, the agents 103, that may indicate a degradation of health of the user devices 102 such as, for example, a rate of the crashes, a rate of processing failures, a rate of data transmission failures, decreased throughput, decreased workloads, decreased connectivity, increased power consumption, increased latency, increased CPU utilization and increased memory utilization over designated time periods where operation of the user devices 102 and/or corresponding components is degrading and/or may be leading up to device or component failure. This data may be also stored in the operational data repository 121.

The data collection engine 120 may harvest data from the administrator devices 105. In illustrative embodiments, harvesting the data from the administrator devices 105 comprises extracting features such as, for example, customers, products, dates of sale, device/part models and types, dates of manufacture, corresponding warranties for devices and parts, and/or device configurations.

In one or more illustrative embodiments, in order to determine connection status of the user devices 102, collecting the operational data comprises scanning a network (e.g., network 104) to detect whether respective ones of the user devices 102 are active on the network. For example, the data collection engine 120 comprises logic to look for specific IP (Internet Protocol) addresses on a network or to discover all IP addresses on a given network. In more detail, the data collection engine 120 may issue “ping” commands to, for example, the agents 103 in the user devices 102, which can be configured with logic to respond to the ping commands if the user devices 102 are active on the network. The data collection engine 120 may further include logic to determine a media access control (MAC) addresses associated with IP addresses. In illustrative embodiments, the data collection engine 120 would be configured to determine which of the user devices 102 responded to a ping request, and leverage an address resolution protocol (ARP) table to find their corresponding MAC addresses. In some embodiments, the data collection engine 120 may utilize a forward table on a network switch or leverage network discovery software to pinpoint specific switch ports to which a user device 102 may be connected.

According to one or more embodiments, the data can be collected at pre-defined time intervals set by, for example, one or more data collection applications such as, but not necessarily limited to, SupportAssist Enterprise available from Dell Technologies. In some embodiments, the data collection engine 120 receives pushed data or pulls data from the agents 103, administrator devices 105 and/or from data collection applications. The machine learning algorithms of illustrative embodiments analyze multiple factors from data collected by the data collection engine 120. The collected data is further used to train the machine learning algorithms.

As noted herein above, with current approaches, users typically wait until devices stop working and/or stop working as expected to approach an enterprise to resell or recycle the devices. As a result, the devices deteriorate beyond the point where they can be refabricated and/or resold, thereby decreasing device sustainability, causing excessive power consumption by devices in disrepair and, overall, resulting in an increased carbon footprint.

Illustrative embodiments provide a machine learning-based model to proactively determine when devices can be resold and/or refabricated. Advantageously, the embodiments predict when devices can be resold and/or refabricated in advance of device deterioration to increase device sustainability and reduce carbon footprint when compared with conventional approaches.

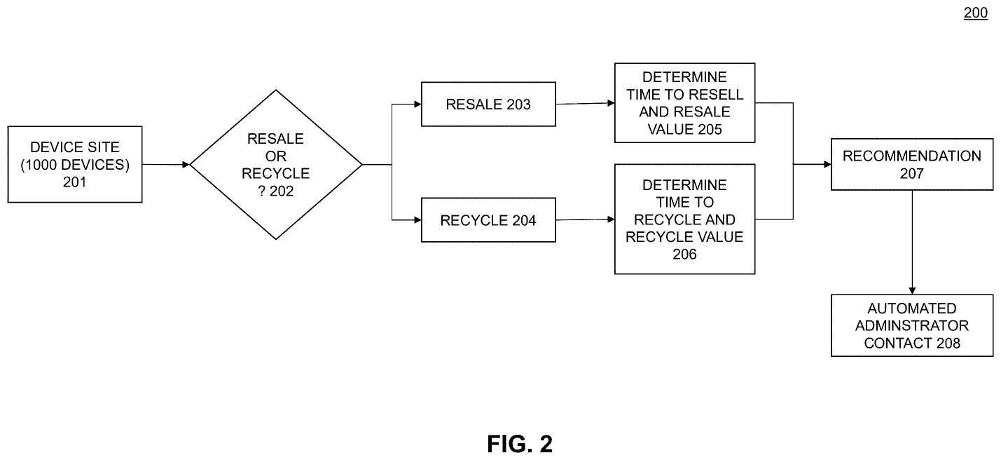

Referring, for example, to the operational flow 200 in FIG. 2, given a device site 201 including multiple user devices 102 (e.g., 1000 devices), based on data collected by the data collection engine 120, the device categorization layer 131 determines whether respective ones of the user devices 102 should be recycled or resold (step 202). In illustrative embodiments, the device categorization layer 131 uses one or more machine learning algorithms to make the determination. The one or more machine learning algorithms comprise, for example, a multiple linear regression algorithm, a convolutional neural network (CNN) and/or one or more decision trees. The multiple linear regression algorithm that is used may be in accordance with the following equation (1):

y=β₀+β₁x₁+β₂x₂+ . . . βₚxₚ+ε (1)
where y is predicted value of the dependent variable (target variable/output variable), β₀ is the y-intercept (value of y when all other parameters are set to 0), β₁x₁ represents the regression coefficient (β₁) of a first independent variable (x₁), 2×2 represents the regression coefficient (2) of a second independent variable (x₂), βₚxₚ represents the regression coefficient (βₚ) of a last independent variable (xₚ), and ε is a model error (variation in an estimate of y). P corresponds to an integer greater than or equal to 1 depending on the number of independent variables.

In more detail, the one or more machine learning algorithms are used to analyze an input dataset comprising one or more independent variables, wherein the one or more independent variables comprise data corresponding to at least one of connection status, power consumption, workloads, crashes, processing failures, data transmission failures, throughput, latency, CPU utilization, memory utilization, age, warranty status, warranty type, serviceable life and model of the respective ones of the user devices 102 and/or parts (e.g., components) of the user devices 102. For example, a given user device 102 may be categorized by the device categorization layer 131 as qualifying for resale (step 203) when the user device 102 has failed to communicate with the device disposition management platform 110 and/or has been inactive for more than a threshold time period (e.g., 30 days), has reduced or no workload, has a designated time left on a warranty (e.g., less than or equal to 6 months) or is out of warranty, but otherwise does not have any health issues. In another example, a given user device 102 may be categorized by the device categorization layer 131 as qualifying for recycling (step 204) when the user device 102 is out of warranty and device health issues are present such as, for example, an increased rate of crashes, an increased rate of processing failures, an increased rate of data transmission failures, decreased throughput, decreased workloads, decreased connectivity, increased power consumption, increased latency, increased CPU utilization and/or increased memory utilization over designated time periods. In alternative embodiments, analysis by the device categorization layer 131 utilizes the machine learning algorithms in combination with one or more rule-based methods to make the determination.

Referring to steps 205 and 206 of the operational flow 200, depending on whether the device categorization layer 131 predicts that a device should be resold (step 203) or recycled (step 204), the resale recommendation layer 132 predicts when to resell a given device and a resale value for the given device (step 205) or when to recycle a given device and a recycle value for the given device (step 206). In a non-limiting operational embodiment, a prediction that a device should be resold (step 203) may be triggered when the following conditions are met: (i) device warranty will expire in 3 months; (ii) battery is covered under an extended battery life warranty; (iii) the device has not been used or has been inactive for more than 30 days; and (iv) the device health is deemed normal. Normal health and deviations from normal health may be determined during training of one or more machine learning algorithms to establish a baseline for normal health, where deviations or anomalies from the baseline will be considered abnormal or problematic health of a device.

The prediction when to resell a given device and a resale value for the given device (step 205) may be based on multiple factors including, but not necessarily limited to, device and/or parts age, device and/or parts warranty type (e.g., level of protection), device and/or parts remaining warranty period, device configuration, support history for the device (e.g., based on number of support tickets created for the device), device and/or parts health, a remaining serviceable life of the model (e.g., has model been discontinued, upgraded, etc.), and/or a remaining serviceable life of the device (e.g., based on how long a particular device has been in use). The resale value of a device may be given in terms of currency (e.g., dollars).

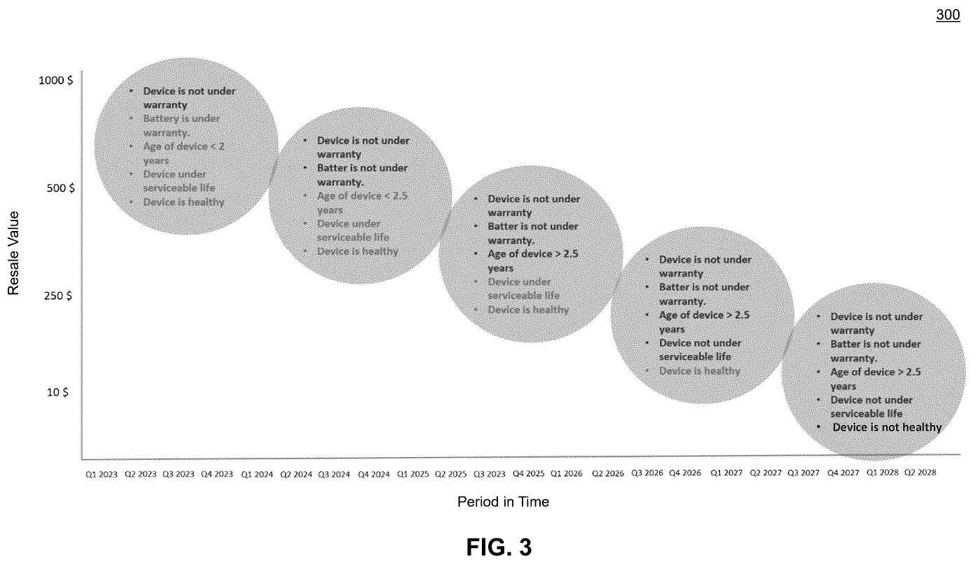

For example, FIG. 3 depicts a graph 300 of factors for determining device resale value. As can be seen in the graph 300 in FIG. 3, the resale recommendation layer 132 may predict resale value based at least in part on, whether the device and/or parts are under warranty, device age, whether there is a remaining serviceable life of the device and whether the device is healthy. As one or more of the devices and parts enter into an out of warranty period, the device age increases, the remaining serviceable life decreases and the device is deemed unhealthy, the resale value decreases.

In a non-limiting operational embodiment, a prediction that a device should be recycled (step 204) may be triggered when the following conditions are met: (i) device warranty has expired; (ii) the device is deemed unhealthy (e.g., abnormal health); and (iii) the device is outside its serviceable life. Abnormal health can be based on a variety of factors including, but not necessarily limited to, finding that device components (e.g., fan, hard drive, battery, etc.) have operational issues such as, for example, consuming more power than usual, losing charge more quickly than usual, are not operating, etc.

The prediction when to recycle a given device and a recycle value for the given device (step 206) may be based on multiple factors including, but not necessarily limited to, device and/or parts age, device and/or parts health, device and/or parts model, device and/or parts type, whether device and/or parts warranties have expired and/or whether a serviceable life of a model and/or device has expired. The recycling value of a device may be given in terms of currency (e.g., dollars).

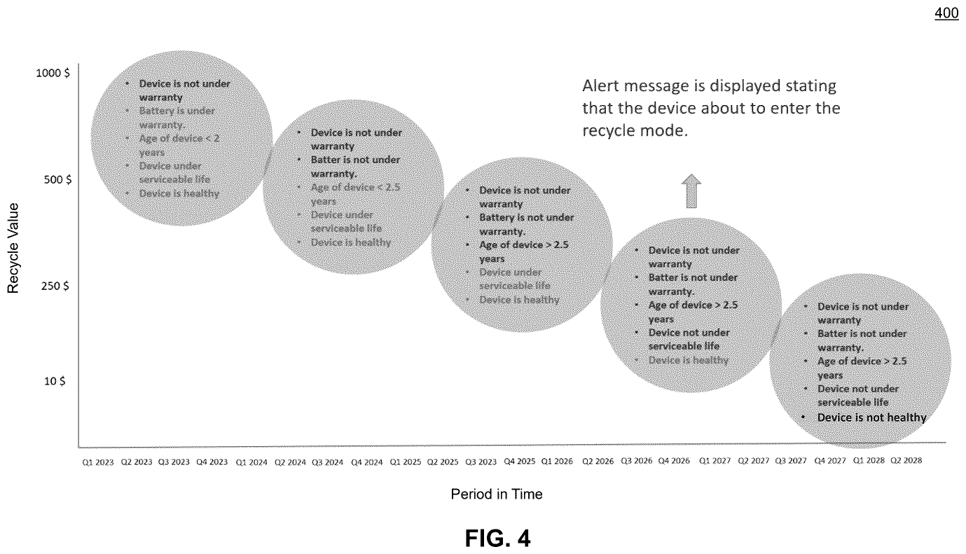

For example, FIG. 4 depicts a graph 400 of factors for determining when to recycle a device instead of reselling the device and for determining device recycle value. As can be seen in the graph 400 in FIG. 4, the recycle recommendation layer 133 may predict when to recycle a device instead of reselling the device and recycle value based at least in part on, whether the device and/or parts are under warranty, device age, whether there is a remaining serviceable life of the device and whether the device is healthy. For example, in the graph 400, an alert is generated indicating that a device will transition from being recommended for resale to being recommended for recycling when the serviceable life of the device expires. The alert may be generated by the alert layer 141 of the inventory management engine 140 in advance of the serviceable life expiring and sent to one or more users or administrators via a user device 102 or an administrator device 105. As one or more of the devices and parts enter into an out of warranty period, the device age increases, the remaining serviceable life decreases and the device is deemed unhealthy, the recycle value decreases.

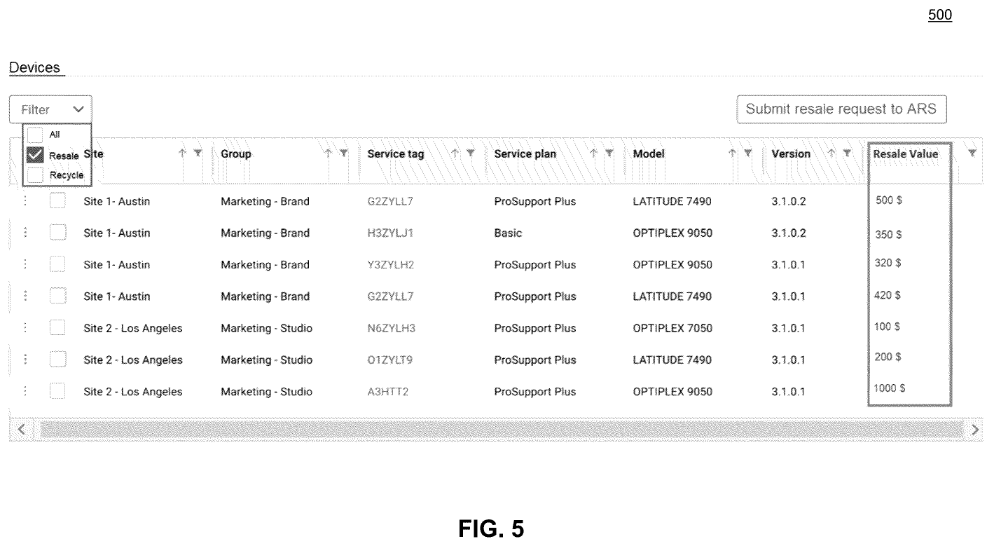

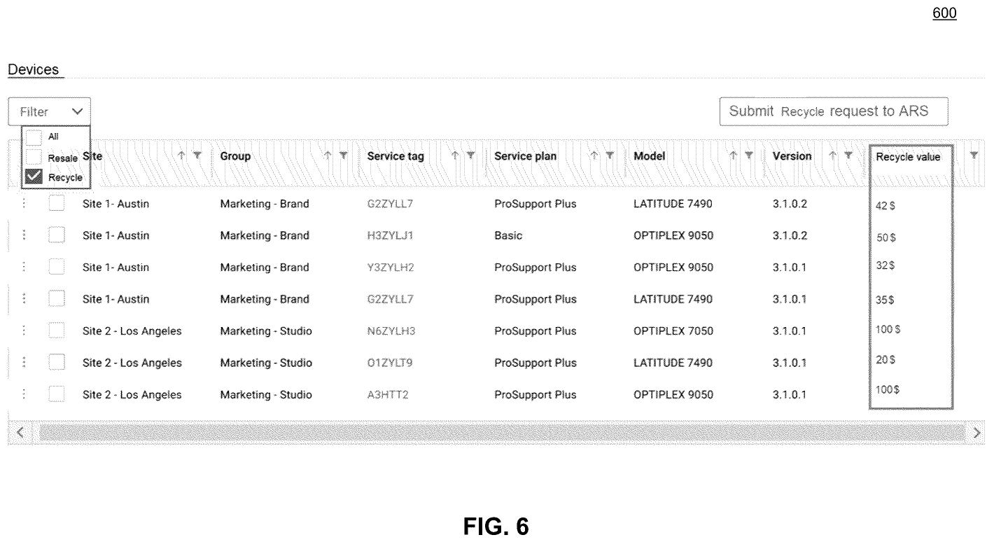

Like the device categorization layer 131, the resale recommendation layer 132 and the recycle recommendation layer 133 use the one or more machine learning algorithms including, for example, the multiple linear regression algorithm, CNNs and/or decision trees described herein above to process an input dataset to make their respective predictions. As noted hereinabove, an input dataset comprises one or more independent variables, wherein the one or more independent variables comprise data corresponding to at least one of connection status, power consumption, workloads, crashes, processing failures, data transmission failures, throughput, latency, CPU utilization, memory utilization, age, warranty status, warranty type, serviceable life and model of the respective ones of the user devices 102 and/or parts (e.g., components) of the user devices 102. Referring to step 207 of the operational flow 200, the alert layer 141 generates and causes transmission of one or more alerts comprising a recommendation to resell or recycle a given one or multiple devices of the respective ones of the user devices 102 within a designated time period. The alert may be sent to a user device 102 and/or administrator device 105 that is connected to and active on the network 104. In illustrative embodiments, the visualization layer 142 generates one or more user interfaces comprising the respective ones of the user devices 102 that have been recommended for resale with their corresponding resale values and/or comprising the respective ones of the user devices 102 that have been recommended for recycling with their corresponding recycle values. For example, FIG. 5 depicts a screenshot 500 of a user interface illustrating resale devices and their corresponding resale values, and FIG. 6 depicts a screenshot 600 of a user interface illustrating recycle devices and their corresponding recycle values. The screenshots 500 or 600 are displayed depending on whether a user selects a resale or recycle filter. An “all” option is also available for a user interface to display both resale and recycle devices and their corresponding values in a combined display. The models, version, service tag, location (site), group and corresponding service plan (warranty) are illustrated for each device in the user interfaces.

The user interfaces in the screenshots 500 and 600 include selectable icons (boxes), where a user can select one or more devices to submit for resale or recycling. Referring to step 208 of the operational flow 200, based on the user selection, the user is automatically directed to an administrator or administrative division of an enterprise (e.g., via a link to a user interface, a generated user interface, opening of a chat or message window, etc.) to process a request for resale or recycling. In illustrative embodiments, the user selection of one or more devices to submit for resale or recycling on a user interface automatically generates a message to an administrator or administrative division of an enterprise to process a request for resale or recycling and/or automatically generates an interface, link to an interface, a message window or a chat window where a user can submit a formal request to an administrator or administrative division of an enterprise to process the resale or recycling of one or more devices.

According to one or more embodiments, the operational data repository 121, warranty data repository 122 and other data repositories or databases referred to herein can be configured according to a relational database management system (RDBMS) (e.g., PostgreSQL). In some embodiments, the operational data repository 121, warranty data repository 122 and other data repositories or databases referred to herein are implemented using one or more storage systems or devices associated with the device disposition management platform 110. In some embodiments, one or more of the storage systems utilized to implement the operational data repository 121, warranty data repository 122 and other data repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the device disposition management platform 110, the data collection engine 120, device management engine 130 and/or inventory management engine 140 in other embodiments can be implemented at least in part externally to the device disposition management platform 110, for example, as stand-alone servers, sets of servers or other types of systems coupled to the network 104. For example, the data collection engine 120, device management engine 130 and/or inventory management engine 140 may be provided as cloud services accessible by the device disposition management platform 110.

The data collection engine 120, device management engine 130 and/or inventory management engine 140 in the FIG. 1 embodiment are each assumed to be implemented using at least one processing device. Each such processing device generally comprises at least one processor and an associated memory, and implements one or more functional modules for controlling certain features of the data collection engine 120, device management engine 130 and/or inventory management engine 140.

At least portions of the device disposition management platform 110 and the elements thereof may be implemented at least in part in the form of software that is stored in memory and executed by a processor. The device disposition management platform 110 and the elements thereof comprise further hardware and software required for running the device disposition management platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the data collection engine 120, device management engine 130, inventory management engine 140 and other elements of the device disposition management platform 110 in the present embodiment are shown as part of the device disposition management platform 110, at least a portion of the data collection engine 120, device management engine 130, inventory management engine 140 and other elements of the device disposition management platform 110 in other embodiments may be implemented on one or more other processing platforms that are accessible to the device disposition management platform 110 over one or more networks. Such elements can each be implemented at least in part within another system element or at least in part utilizing one or more stand-alone elements coupled to the network 104.

It is assumed that the device disposition management platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the data collection engine 120, device management engine 130, inventory management engine 140 and other elements of the device disposition management platform 110, and the elements thereof can each be implemented in the form of one or more LXCs running on one or more VMs. Other arrangements of one or more processing devices of a processing platform can be used to implement the data collection engine 120, device management engine 130 and inventory management engine 140, as well as other elements of the device disposition management platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the device disposition management platform 110 to reside in different data centers. Numerous other distributed implementations of the device disposition management platform 110 are possible.

Accordingly, one or each of the data collection engine 120, device management engine 130, inventory management engine 140 and other elements of the device disposition management platform 110 can each be implemented in a distributed manner so as to comprise a plurality of distributed elements implemented on respective ones of a plurality of compute nodes of the device disposition management platform 110.

It is to be appreciated that these and other features of illustrative embodiments are presented by way of example only, and should not be construed as limiting in any way. Accordingly, different numbers, types and arrangements of system elements such as the data collection engine 120, device management engine 130, inventory management engine 140 and other elements of the device disposition management platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the device disposition management platform can be offered to cloud infrastructure customers or other users as part of FaaS, CaaS and/or PaaS offerings.

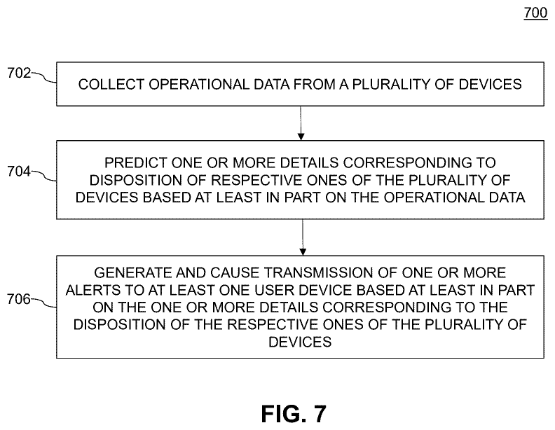

The operation of the information processing system 100 will now be described in further detail with reference to the flow diagram of FIG. 7. With reference to FIG. 7, a process 700 for device disposition management as shown includes steps 702 through 706, and is suitable for use in the system 100 but is more generally applicable to other types of information processing systems comprising a device disposition management platform configured for predicting and controlling disposition of devices.

In step 702, operational data is collected from a plurality of devices. In step 704, one or more details corresponding to disposition of respective ones of the plurality of devices are predicted based at least in part on the operational data. In illustrative embodiments, the operational data is collected via respective software agents in the respective ones of the plurality of devices and comprises data corresponding to at least one of connection status, power consumption, workloads, crashes, processing failures, data transmission failures, throughput, latency, CPU utilization and memory utilization of the respective ones of the plurality of devices. The collecting of the operational data may comprise scanning at least one network to detect whether the respective ones of the plurality of devices are active on the at least one network.

Step 706 includes generating and causing transmission of one or more alerts to at least one user device based at least in part on the one or more details corresponding to the disposition of the respective ones of the plurality of devices. In illustrative embodiments, the one or more alerts comprise a recommendation to at least one of resell and recycle a given one of the respective ones of the plurality of devices within a designated time period. At least one user interface may be generated comprising the respective ones of the plurality of devices that are recommended to be resold with corresponding resale values of the respective ones of the plurality of devices that are recommended to be resold. At least one user interface may be generated comprising the respective ones of the plurality of devices that are recommended to be recycled with corresponding recycle values of the respective ones of the plurality of devices that are recommended to be recycled.

In illustrative embodiments, predicting the one or more details corresponding to the disposition of the respective ones of the plurality of devices comprises determining whether there is a degradation of health of the respective ones of the plurality of devices based on a least one of a rate of the crashes, a rate of the processing failures, a rate of the data transmission failures, decreased throughput, decreased workloads, decreased connectivity, increased power consumption, increased latency, increased CPU utilization and increased memory utilization over designated time periods.

The predicting can be performed using one or more machine learning algorithms, the one or more machine learning algorithms comprising at least one of a multiple linear regression algorithm, a CNN and one or more decision trees. The one or more machine learning algorithms may be trained with historical data comprising disposition of multiple devices and corresponding operational data and warranty data for the multiple devices. The one or more machine learning algorithms may be used to analyze an input dataset comprising one or more independent variables, wherein the one or more independent variables comprise data corresponding to at least one of connection status, power consumption, workloads, crashes, processing failures, data transmission failures, throughput, latency, central processing unit utilization, memory utilization, age, warranty status, warranty type and model of the respective ones of the plurality of devices.

The predicting may be further based at least in part on data corresponding to at least one of age, warranty status, warranty type, and model of the respective ones of the plurality of devices. The predicting may also be based at least in part on data corresponding to at least one of a status of one or more parts, a health of one or more parts, an age of one or more parts, a model of one or more parts and a type of one or more parts of the respective ones of the plurality of devices.

In illustrative embodiments, the one or more details comprise at least one of whether the respective ones of the plurality of devices are recommended to be resold, whether the respective ones of the plurality of devices are recommended to be recycled, when the respective ones of the plurality of devices are recommended to be resold, when the respective ones of the plurality of devices are recommended to be recycled, a resale value of the respective ones of the plurality of devices, and a recycle value of the respective ones of the plurality of devices.

It is to be appreciated that the FIG. 7 process and other features and functionality described above can be adapted for use with other types of information systems configured to execute replacement component management services in a device disposition management platform or other type of platform.

The particular processing operations and other system functionality described in conjunction with the flow diagram of FIG. 7 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 7 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a device disposition management platform as disclosed herein can provide a number of significant advantages relative to conventional arrangements. For example, the device disposition management platform effectively uses machine learning techniques to predict ideal times for reselling or recycling devices. Additionally, the illustrative embodiments provide a technical solution where users are notified about reselling devices in a window of time before recycling of the devices becomes the only option. Unlike conventional approaches, the illustrative embodiments advantageously increase the ability for devices to be sold at the appropriate time which maximizes their condition for refurbishment and reuse, ultimately increasing their lifespan and functionality. The embodiments reduce carbon footprint by minimizing power consumption by devices in disrepair and by reducing electronic waste that may be placed in landfills.

Unlike current approaches, the illustrative embodiments provide a proactive method to predict device eligibility for resale or recycling based on real-time device health, device maintenance cycles and expected health degradation. The illustrative embodiments also proactively determine a product's resale or recycle value based on a variety of factors such as, for example, warranties and technical support and maintenance history. The illustrative embodiments advantageously enhance the sustainability of device sites (e.g., datacenters) by reducing power consumption, simplifying device disassembly, and by recycling and prolonging the useful life of devices.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the device disposition management platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a device disposition management platform in illustrative embodiments. These and other cloud-based systems in illustrative embodiments can include object stores.

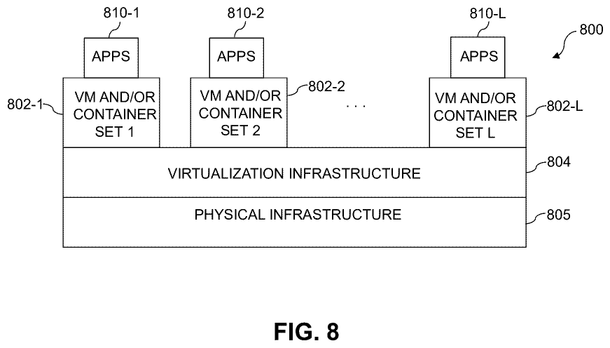

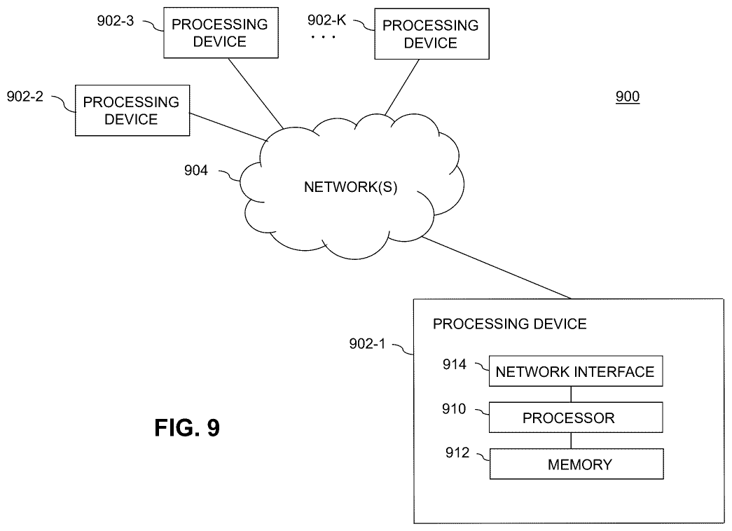

Illustrative embodiments of processing platforms will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. A hypervisor platform may be used to implement a hypervisor within the virtualization infrastructure 804, where the hypervisor platform has an associated virtual infrastructure management system. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 902-1 in the processing platform 900 comprises a processor 910 coupled to a memory 912. The processor 910 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 912 may comprise random access memory (RAM), read-only memory (ROM), flash memory or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the device disposition management platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and device disposition management platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
collecting operational data from a plurality of devices;
predicting one or more details corresponding to disposition of respective ones of the plurality of devices based at least in part on the operational data; and
generating and causing transmission of one or more alerts to at least one user device based at least in part on the one or more details corresponding to the disposition of the respective ones of the plurality of devices;
wherein the steps of the method are executed by a processing device operatively coupled to a memory.

2. The method of claim 1 wherein the operational data is collected via respective software agents in the respective ones of the plurality of devices and comprises data corresponding to at least one of connection status, power consumption, workloads, crashes, processing failures, data transmission failures, throughput, latency, central processing unit utilization and memory utilization of the respective ones of the plurality of devices.

3. The method of claim 2 wherein predicting the one or more details corresponding to the disposition of the respective ones of the plurality of devices comprises determining whether there is a degradation of health of the respective ones of the plurality of devices based on a least one of a rate of the crashes, a rate of the processing failures, a rate of the data transmission failures, decreased throughput, decreased workloads, decreased connectivity, increased power consumption, increased latency, increased central processing unit utilization and increased memory utilization over designated time periods.

4. The method of claim 1 wherein the predicting is performed using one or more machine learning algorithms, the one or more machine learning algorithms comprising at least one of a multiple linear regression algorithm, a convolutional neural network and one or more decision trees.

5. The method of claim 1 wherein:
the predicting is performed using one or more machine learning algorithms; and
the method further comprises training the one or more machine learning algorithms with historical data comprising disposition of multiple devices and corresponding operational data and warranty data for the multiple devices.

6. The method of claim 1 wherein the predicting comprises using one or more machine learning algorithms to analyze an input dataset comprising one or more independent variables, wherein the one or more independent variables comprise data corresponding to at least one of connection status, power consumption, workloads, crashes, processing failures, data transmission failures, throughput, latency, central processing unit utilization, memory utilization, age, warranty status, warranty type and model of the respective ones of the plurality of devices.

7. The method of claim 1 wherein the predicting is further based at least in part on data corresponding to at least one of age, warranty status, warranty type, and model of the respective ones of the plurality of devices.

8. The method of claim 1 the predicting is further based at least in part on data corresponding to at least one of a status of one or more parts, a health of one or more parts, an age of one or more parts, a model of one or more parts and a type of one or more parts of the respective ones of the plurality of devices.

9. The method of claim 1 wherein the one or more details comprise at least one of whether the respective ones of the plurality of devices are recommended to be resold, whether the respective ones of the plurality of devices are recommended to be recycled, when the respective ones of the plurality of devices are recommended to be resold, when the respective ones of the plurality of devices are recommended to be recycled, a resale value of the respective ones of the plurality of devices, and a recycle value of the respective ones of the plurality of devices.

10. The method of claim 9 wherein the one or more alerts comprise a recommendation to at least one of resell and recycle a given one of the respective ones of the plurality of devices within a designated time period.

11. The method of claim 9 further comprising generating at least one user interface comprising the respective ones of the plurality of devices that are recommended to be resold with corresponding resale values of the respective ones of the plurality of devices that are recommended to be resold.

12. The method of claim 9 further comprising generating at least one user interface comprising the respective ones of the plurality of devices that are recommended to be recycled with corresponding recycle values of the respective ones of the plurality of devices that are recommended to be recycled.

13. The method of claim 1 wherein collecting the operational data comprises scanning at least one network to detect whether the respective ones of the plurality of devices are active on the at least one network.

14. An apparatus comprising:
a processing device operatively coupled to a memory and configured:
to collect operational data from a plurality of devices;
to predict one or more details corresponding to disposition of respective ones of the plurality of devices based at least in part on the operational data; and
to generate and cause transmission of one or more alerts to at least one user device based at least in part on the one or more details corresponding to the disposition of the respective ones of the plurality of devices.

15. The apparatus of claim 14 wherein the operational data is collected via respective software agents in the respective ones of the devices and comprises data corresponding to at least one of connection status, power consumption, workloads, crashes, processing failures, data transmission failures, throughput, latency, central processing unit utilization and memory utilization of the respective ones of the plurality of devices.

16. The apparatus of claim 14 wherein:
the predicting is performed using one or more machine learning algorithms; and
the processing device is further configured to train the one or more machine learning algorithms with historical data comprising disposition of multiple devices and corresponding operational data and warranty data for the multiple devices.

17. The apparatus of claim 14 wherein, in predicting the one or more details corresponding to disposition of the respective ones of the plurality of devices, the processing device is configured to use one or more machine learning algorithms to analyze an input dataset comprising one or more independent variables, wherein the one or more independent variables comprise data corresponding to at least one of connection status, power consumption, workloads, crashes, processing failures, data transmission failures, throughput, latency, central processing unit utilization, memory utilization, age, warranty status, warranty type and model of the respective ones of the plurality of devices.

18. An article of manufacture comprising a non-transitory processor-readable storage medium having stored therein program code of one or more software programs, wherein the program code when executed by at least one processing device causes said at least one processing device to perform the steps of:
collecting operational data from a plurality of devices;
predicting one or more details corresponding to disposition of respective ones of the plurality of devices based at least in part on the operational data; and
generating and causing transmission of one or more alerts to at least one user device based at least in part on the one or more details corresponding to the disposition of the respective ones of the plurality of devices.

19. The article of manufacture of claim 18 wherein the operational data is collected via respective software agents in the respective ones of the devices and comprises data corresponding to at least one of connection status, power consumption, workloads, crashes, processing failures, data transmission failures, throughput, latency, central processing unit utilization and memory utilization of the respective ones of the plurality of devices.

20. The article of manufacture of claim 18 wherein, in predicting the one or more details corresponding to disposition of the respective ones of the plurality of devices, the program code causes said at least one processing device to use one or more machine learning algorithms to analyze an input dataset comprising one or more independent variables, wherein the one or more independent variables comprise data corresponding to at least one of connection status, power consumption, workloads, crashes, processing failures, data transmission failures, throughput, latency, central processing unit utilization, memory utilization, age, warranty status, warranty type and model of the respective ones of the plurality of devices.
